(19) United States
(12) Patent Application Publication
(10) Pub. No.: US 2014/0278801 A1
(43) Pub. Date: Sep. 18, 2014

(54) Modular Complexing System for Deployment of Shelters

(71) Applicant: BERG COMPANIES, INC., Spokane, WA (US)

(72) Inventors: Andrew N. Barrett, Coeur d' Alene, ID (US); Douglas Wayne Combs, Spokane, WA (US); Paul Gorka, Spokane, WA (US)

(73) Assignee: BERG COMPANIES, INC., Spokane, WA (US)

(21) Appl. No.: 13/841,765

(22) Filed: Mar. 15, 2013

(51) Int. Cl. G06Q 30/02

(52) U.S. Cl. CPC G06Q 30/0205
USPC 705/7.34

(57) ABSTRACT

Expandable shelters housing displaceable cassettes configured to provide an allocated resource are disclosed. Techniques of complexing the expandable shelters housing displaceable cassettes are also disclosed. The displaceable cassettes may deploy from a stowed position in an interior of the expandable shelter to a use position removeably coupled in an expanded interior portion of a displaceable side of the expandable shelter. In the use position, the cassettes are configured to provide an allocated resource, and provide a hallway between other interconnected expandable shelters.

### PRIORITY

This application claims the benefit of the filing date of U.S. Provisional Application No. 61/620,066 filed on Apr. 4, 2012, which is incorporated by reference herein in its entirety.

### BACKGROUND

Expandable shelters exist that are made to order. For example, expandable shelters exist that are uniquely configured units and outfitted based on particular customer requirements. In addition, these expandable shelters are permanently configured in the way they were ordered by the customer. For example, an expandable shelter may be made to provide a resource suitable for use in the arctic and, as such, not suitable for use in the tropics.

Further, subsequent to being permanently configured, the expandable shelters can only connect to each other in limited ways. For example, an expandable shelter may be configured to provide a resource (e.g., a kitchen, a bathroom, a latrine, etc.) arranged in a center of the expandable shelter and having only in and out access to the resource. In this example, where the expandable shelter has a centrally arranged resource, it may be possible to connect other expandable shelters to respective ends of the expandable shelter having the resource, however the centrally arranged resource typically obstructs and prevents passage through the central portion of the expandable shelter. Stated otherwise, expandable shelters having a centrally arranged resource are not capable of providing interconnection (e.g., a hallway, walkway, pass-through, thoroughfare, etc.) between attached expandable shelters, thus limiting connections between expandable shelters.

Accordingly, there remains a need for expandable shelters that are modular and adaptable to different configurations.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIGS. 1A through 1D depict an illustrative expandable shelter and cassettes displaceably housed in an interior of the expandable shelter.

FIG. 2 depicts an illustrative view of a cassette in a use position removeably coupled in an expanded interior portion of a displaceable side of an expandable shelter.

FIGS. 3A through 3F depict illustrative views of example embodiments of a cassette configured to provide an allocated resource.

FIG. 4 depicts an example user interface for a user to provide information about a desired camp.

FIG. 5 depicts an example user interface for a user to build a desired camp.

FIG. 6 illustrate a processes related to a user providing information about a desired camp.

FIG. 7 illustrate a processes related to building a desired camp.

### DETAILED DESCRIPTION

### Overview

This application describes expandable shelters having cassettes configured to provide an allocated resource displaceably housed in the expandable shelters, and techniques directed to complexing these and other expandable shelters. By virtue of having cassettes displaceably housed in the expandable shelters, the expandable shelters are capable of complexing (e.g., interconnecting) with other expandable shelters.

In one example, the expandable shelters may include a cassette displaceably housed in an interior of the expandable shelter to deploy from a stowed position in the interior of the expandable shelter to a use position. In the use position, the cassette is removeably coupled in an expanded interior portion of a displaceable side of the expandable shelter. The cassettes may be configured to provide a variety of resources. For example, a cassette may be configured to provide a water resource, a telecommunication resource, a computing resource, a medical resource, a forensic resource, a kitchen resource, a latrine resource, a bath resource, a bunk (e.g., sleeping or bedding) resource, etc.

In some examples, a cassette may include standardized quick connect fittings to make-or-break connections of cooperating standardized quick connect fittings arranged in any expandable shelter.

In some examples, the cassettes may be configured for a particular climate. For example, a cassette may be configured for a frigid climate, temperate climate, or a torrid climate of the Earth.

While the expandable shelters housing cassettes are described in various embodiments herein as being about one third the size of the intermodal shipping container, the expandable shelters housing cassettes may be any other size. For example, the expandable shelters housing cassettes may be about one quarter, one half, or equivalent to the size of the intermodal shipping container. Further, while the expandable shelters are described in various embodiments herein as being formed of an intermodal shipping container, the expandable shelters do not have to be formed of an intermodal shipping container.

Further, while the expandable shelters are described in various embodiments herein as having expandable sides between the front and back ends, the expandable shelters may have other expandable portions. For example, the expandable shelters may additionally or alternatively comprise an expandable top, front, back, or any combination thereof.

### Illustrative Expandable Shelter and Cassette Systems

FIGS. 1A through 1D depict an illustrative expandable shelter 102 and displaceable cassettes 104(A) and 104(B). FIG. 1A illustrates that the expandable shelter 102 may include a container 106 defining an interior 108. The container 106 may have a top 110, a bottom 112, a front 114, a back 116, and two sides 118(A) and 118(B). The front 114, back 116, and/or the sides 118(A) and 118(B) may be displaceably attached to the container 106 to deploy from a stowed position 120 to a use position 122. In the stowed position 120, the front 114, back 116, and/or sides 118(A) and 118(B) may be adjacent to the container 106. In the use position 122, the front 114, back 116, and/or sides 118(A) and 118(B) may be out and away from the container 106.

FIG. 1B illustrates the front 114 and the back 116 deployed in the use position 122, and the sides 118(A) and 118(B) in the stowed position 120. The front 114 and/or back 116, deployed in the use position 122, may provide access to the cassettes 104(A) and/or 104(B) displaceably housed in the interior 108 of the container 106. For example, when the front 114 and/or back 116 is deployed in the use position 122, the front 114 and/or back 116 may provide a doorway 124 to enter the expandable shelter 102. Further, the interior 108 of the container 106 may have surface area 126 suitable to house the cassettes 104(A) and 104(B).

FIG. 1B illustrates that the cassettes 104(A) and 104(B) may be in a stowed position 128 in the interior 108 of the container 106. For example, the cassettes 104(A) and 104(B) may be in the stowed position 128 (e.g., locked, anchored, fixed, etc.) in the interior 108 of the container 106 for transport.

FIGS. 1C and 1D illustrate the front 114, the back 116, and the sides 118(A) and 118(B) deployed in the use position 122. The front 114, the back 116, and/or the sides 118(A) and 118(B) may fold down, out, and away from the container 106. For example, the front 114, the back 116, and the sides 118(A) and 118(B) may include foldable frames connected to the container 106 and provide for folding the front 114, the back 116, and/or the sides 118(A) and 118(B) down, out, and away relative to the container 106. A cover, formed of a soft flexible material (e.g., a fabric, a plastic, a composite), may be coupled to the front 114, the back 116, the sides 118(A) and 118(B), and/or the foldable frames. In the use position 122, the displaceable front 114, back 116, and sides 118(A) and 118(B) define expanded interior portions 130(A), 130(B), 130(C), and 130(D), respectively.

With the displaceable sides 118(A) and 118(B) deployed to the use position 122, out and away from the container 106, the cassettes 104(A) and 104(B) may be deployed from the stowed position 128 in the interior 108 of the container 106 to a use position 132 removeably coupled in the expanded interior portions 130(C) and 130(D), respectively.

A pair of doors 134(A) and 134(B) may be detached (e.g., removed) to allow passage of the cassettes 104(A) and 104(B) from the interior 108 to the expanded interior portions 130(C) and 130(D), and subsequently reattached. For example, the doors 134(A) and 134(B) may be removeably coupled to the container 106 via a hook-and-loop fastener, a snap fit fastener, a press fit fastener, a zipper, or the like, to enable the doors 134(A) and 134(B) to be easily detached and reattached.

Subsequent to detaching the doors 134(A) and/or 134(B), the cassettes 104(A) and 104(B) may be displaced into the expanded interior portions 130(C) and 130(D) and make connections with quick connect fittings. For example, as the cassettes 104(A) and 104(B) are moved into the expanded interior portions 130(C) and 130(D), quick connect fittings arranged in the cassettes 104(A) and 104(B) may make connections (e.g., blind mate connections) with quick connect fittings arranged in the expanded interior portions 130(C) and 130(D) of the expandable shelter 102 (described in more detail below with regard to FIG. 2). By moving the cassettes 104(A) and 104(B) into the expanded interior portions 130(C) and 130(D) and making or coupling the connections between the cassettes 104(A) and 104(B) and the expanded interior portions 130(C) and 130(D), the displaceable cassettes 104(A) and 104(B) may be defined to be removeably coupled in the expanded interior portions 130(C) and 130(D) of the displaceable sides 118(A) and 118(B).

After deploying the displaceable cassettes 104(A) and 104(B) to the use position 132, the doors 134(A) and 134(B) may be attached in the interior 108 of the container 106. For example, the doors 134(A) and 134(B) may be attached in the interior 108 of the container 106 to separate the expanded interior portions 130(C) and 130(D) of the displaceable sides 118(A) and 118(B) from the interior 108 of the container 106. Further, the doors 134(A) and 134(B) may be re-attached by removeably coupling the doors 134(A) and 134(B) to the container 106 via hook-and-loop fastener, snap fit fastener, press fit fastener, zipper, or the like.

FIG. 1C illustrates the cassette 104(B) deployed to the use position 132 removeably coupled in the expanded interior portion 130(D) of the expandable side 118(B). FIG. 1D illustrates both the cassettes 104(A) and 104(B) deployed to the use position 132 removeably coupled in the expanded interior portions 130(C) and 130(D) of the expandable sides 118(A) and 118(B). Once the cassettes 104(A) and/or 104(B) are deployed to the use position 132, the cassettes 104(A) and 104(B) may be configured to provide an allocated resource, and the interior 108 of the container 106 may provide a hallway, a walkway, pass-through, thoroughfare, etc. between the front 114 and the back 116. For example, a user may enter the front 114, pass through the interior 108, and exit the back 116. Further, additional shelters may be interconnected to the front 114 and/or to the back 116, and a user may pass through the interior 108 of the expandable shelter 102 to enter either shelter interconnected to the front 114 and/or to the back 116. Because the expandable shelter 102 may interconnect other shelters, and the cassettes 104(A) and 104(B) are displaceable and provide a hallway between interconnected expandable shelters, the expandable shelter 102 provides for complexing shelters.

FIG. 2 depicts an illustrative view of the cassette 104(B) removeably coupled in the expanded interior portion 130(D) of the displaceable side 118(B) of the expandable shelter 102. The cassette 104(B) may be arranged adjacent to a wall 202 of the expanded interior portion 130(D). For example, the cassette 104(B) may be displaced into the expanded interior portion 130(D) until the cassette 104(B) is proximate to, or comes in contact with, the wall 202. The cassette 104(B) may include quick connect fittings 204 arranged in a back portion 206 of the cassette 104(B). The quick connect fittings 204 may make connections (e.g., blind mate connections) with quick connect fittings 208 arranged in the wall 202 of the expanded interior portion 130(D) of the expandable shelter 102.

The quick connect fittings 204 and 208 may provide for connecting the cassette to water, septic, heating, ventilation, air conditioning (e.g., HVAC), electricity, gas, compressed air, communications, or the like, based on what type of allocated resource the cassette 104(B) is configured to provide. For example, the cassette 104(B) may be configured to provide a kitchen resource, and the quick connect fittings 204 and 208 may provide for connecting potable water, gas, and/or septic to the kitchen resource arranged in the cassette 104(B). Further, and as another example, the cassette 104(B) may be configured to provide a computing resource (e.g., an unmanned aerial vehicle remote control station, a telecommunications station, a radio station, etc.), and the quick connect fittings 204 and 208 may provide for connecting power, communications, and/or HVAC to the computing resource arranged in the cassette 104(B).

FIGS. 3A through 3F depict illustrative views of example embodiments of cassettes 302 configured to provide an allocated resource 304. Each cassette 302 may include a base 306 having a surface area 308 smaller than the surface area 126 of the interior of the container 106. For example, the surface area 308 of the base 306 may be smaller than the surface area 126 of the interior of the container 106 to provide for the base 306 to be displaceably deployed from the stowed position 128 to the use position 132. The allocated resource 304 may be arranged within the surface area 308 of the base 306 and fixed to the base 306. Further, the allocated resource 304 may be arranged to be confined or restricted within the surface area 308 of the base 306.

The base 306 may be standardized across cassettes 302 and/or containers 106. For example, the surface area 308 of the base 306 may be the same surface area 308 for all cassettes 302. Specifically, the surface area 308 of the base 306 may be substantially rectangular in shape and have a length 310 smaller than the length of the surface area 126 of the interior 108 of the container 106. Further, the surface area 308 of the base 306 may be smaller than a surface area of the expanded interior portions 130(C) and 130(D) of the expandable sides 118(A) and 118(B).

The base 306 may be configured to provide more than one allocated resources 304 at a time. For example, the surface area 308 of the base 306 may provide first and second portions 312(A) and 312(B) configured to receive first and second allocated resources 314(A) and 314(B), respectively. The first and second allocated resources 314(A) and 314(B) may be the same or different. For example, the first and second allocated resources 314(A) and 314(B) may both be showers, or the first and second allocated resources 314(A) and 314(B) may be a shower and a stacked washer and dryer.

The cassettes 302 may include casters 316 fixed to the base 306 opposite to the allocated resource 304 to provide for the cassette 302 to be displaceable and to deploy from the stowed position 120 to the use position 132. While the cassettes 302 are illustrated as being mounted on casters 316, the cassettes 302 may be mounted on a rail, a track, a bearing surface, or the like, to provide for the cassettes 302 to be displaceable and to deploy from a stowed position 120 to a use position 132.

FIG. 3A illustrates the first and second allocated resources 314(A) and 314(B) consisting of a stacked washer and dryer resource and a bath resource, respectively. FIG. 3B illustrates a cassette 302 configured to provide an allocated resource 304 consisting of a kitchen resource. FIG. 3C illustrates the first and second allocated resources 314(A) and 314(B) consisting of a latrine resource, and a bath resource, respectively. FIG. 3D illustrates a cassette 302 configured to provide an allocated resource 304 consisting of a computing resource. FIG. 3E illustrates a cassette 302 configured to provide an allocated resource 304 consisting of a drone control station resource. FIG. 3F illustrates a cassette 302 configured to provide an allocated resource 304 consisting of a power resource.

The cassettes 302 may be configured for a particular climate and/or geographic location. For example the cassettes 302 may be configured for a frigid climate, temperate climate, a torrid climate, or other climates. Further, the cassettes 302 may be configured based on when during an annual season a cassette 302 is to be deployed to the geographic location.

As an example, in an embodiment where the cassettes 302 may be deployed to a frigid climate (e.g., the Arctic and/or the Antarctic), the cassettes 302 illustrated in FIGS. 3A through 3C may include insulated walls 318 and/or insulated plumbing 320. Further, in the embodiment where the cassettes 302 may be deployed to a frigid climate during a winter season, the cassettes 302 illustrated in FIGS. 3A through 3C may include heavier insulation than if the cassettes 302 were deployed to the frigid climate during a summer season.

As an example, in an embodiment where the cassettes 302 may be deployed to a torrid climate (e.g., a tropical location and/or a desert location) the cassettes 302 may include specific allocated resources 304 tailored to the location. For example, in an embodiment where the cassettes 302 may be deployed to a tropical location, an allocated resource 304 consisting of a water resource may be minimized or reduced (e.g., smaller sized reservoirs), while another allocated resource 304 consisting of a power resource may be maximized or enhanced (e.g., more and/or larger solar panels and/or windmills). Alternatively, in an embodiment where the cassettes 302 may be deployed to a desert location, the allocated resource 304 consisting of the water resource may be maximized or enhanced (e.g., larger sized reservoirs), while the other allocated resource 304 consisting of the power resource (e.g., power resource) may be minimized or reduced (e.g., fewer and/or smaller solar panels and/or windmills).

The cassettes 302 may be stored in storage (e.g., a depot) until a time of use. For example, replacement cassettes 302 may be stored in the field as back-up replacements if a cassette in use fails. Further, the cassettes 304 may be stored at a depot until a time of use. For example, cassettes 304 may be selected from the depot based on a camp configuration.

### Illustrative User Interfaces

FIG. 4 depicts an example user interface 402 for a user to provide information about a desired camp. For example, the user interface 402 may allow a user to provide information about a camp that needs to be deployed to locations and be capable of independent operation. The user interface 402 may utilize the provided information, standards (e.g., military standards), and/or requirements associated with the type of user to determine types of shell components or qualified shell components needed to build the camp. For example, the user interface 402 may utilize shell components including, but not limited to, expandable shelters configured to provide commercial, industrial, military, or other uses.

The expandable shelters may be formed of shipping containers, such as intermodal shipping containers. For example, an expandable shelter may be formed of a shipping container conforming to International Organization for Standardization (ISO). For example, the expandable shelters may be about 20 feet in length, about 8 feet in width, and about 10 feet in height. Further, the expandable shelters provided as shell components may also include expandable shelters having a length of about a third the standard 20 foot length (i.e., a TRICON), a length of about a half the standard 20 foot length (i.e., a BICON), a length of about a quarter the standard 20 foot length (i.e., a QUADCON).

The expandable shelters may be configured to include a single displaceable front, back, or side, to deploy from a stowed position adjacent to the container to a use position out and away from the container. Further, some, or all of the front, back, or sides may be displaceably deployed from a stowed position adjacent to the container to a use position out and away from the container. For example, the shell components may include expandable shelters having two expandable sides (i.e., a 3-in-1), three expandable sides (i.e., a 4-in-1), and/or four expandable sides (i.e., a 5-in-1).

The shell components may include cassettes (e.g., cassettes 104(A), 104(B), and/or 302), and/or expandable shelters (e.g., expandable shelter 102) configured to house the cassettes. For example, the user interface 402 may enable a user to select shell components including, but not limited to, a 5-in-1 TRICON configured to house cassettes, a 4-in-1, and/or a 3-in-1 configured to house cassettes.

As discussed above with regard to FIGS. 3A through 3F, the cassettes may be configured to provide an allocated resource (e.g., allocated resource 304). Further, the cassettes may be configured for a particular climate, and/or geographic location.

In some instances, the user interface 402 may be displayed on a site of a provider of expandable shelters. Further, the user interface 402 may be displayed on a site of a private buyer, such as a private site not available to the public. The user interface 402 may be displayed via, for example, a browser, an application, and so forth.

The user interface 402 may allow a user to select a type of user of the expandable shelters. For example, the user interface 402 may include a drop down menu 404 listing different types of potential users of expandable shelters. The different types of potential users of expandable shelters may include a military type user 406 (e.g., Army, Marine Corps, Navy, Air Force, Coast Guard, etc.), a defense contractor type user 408, a disaster relief type user 410, a construction contractor type user 412, etc. Here, FIG. 4 illustrates a selection of an Air Force type user 414, within the military drop down menu.

The user interface 402 may allow a user to select a location where the expandable shelters are to be deployed. For example, the user interface 402 may include a drop down menu 416 listing geographic locations to which the expandable shelters could potentially be deployed to. Further, the user interface 402 may include a web mapping service displaying geographical locations the expandable shelters could potentially be deployed. A user may select, from the drop down menu 416 or the mapping service, the location to which the expandable shelters are to be deployed. Here, FIG. 4 illustrates a selection of Afghanistan 418 as the geographical location the expandable shelters are to be deployed to. While FIG. 4 illustrates a detail level of selection at the state or country level, the drop down menu 416 or the mapping service may provide further details as to where the expandable shelters are to be deployed. For example, the drop down menu 416 may provide details including a province, a city, a town, a latitude and a longitude coordinate, or the like.

The user interface 402 may allow a user to select a season when the expandable shelters are to be deployed. For example, the user interface 402 may include a drop down menu 420 listing seasons of the selected geographic location. Here, FIG. 4 illustrates a selection of a winter season 422.

The user interface 402 may allow a user to select a gender of the group of people to occupy the expandable shelters. For example, the user interface 402 may include a drop down menu 424 listing all male, mixed male and female, and all female groups. Here, FIG. 4 illustrates a selection of a mixed male and female group 426 to populate the expandable shelters.

The user interface 402 may allow a user to select a number of people to occupy the expandable shelters. For example, the user interface 402 may include a drop down menu 428 listing a range of quantities from at least about 25 people up to at most about 600 people. Here, FIG. 4 illustrates a selection of a quantity of 25 people 430 to populate the expandable shelters.

Subsequent to the user providing the information, the user may submit a request for types of shell products based on the provided information via a submit button 432. For example, the user may submit a request for qualified shell products including shelters and/or expandable shelters (e.g., expandable shelters configured to house cassettes, cassettes, tents, or the like) via the submit button 432.

FIG. 5 depicts an example user interface 502 for a user to build a desired camp. For example, the user interface 502 may provide for complexing shell products and/or interconnecting expandable shelters to build a desired camp.

The user interface 502 may include a drop down menu 504 listing shell products determined to be qualified based on the user information provided via the user interface 402. For example, the drop down menu 504 listing shell products may provide a type of the expandable shelters and a type of the cassettes to be housed in the expandable shelters based on the information received via the drop down menus 404, 416, 420, 424, and/or 428.

In addition, pull down menu 504 may include a pull down menu listing an inventory. For example, the pull down menu 504 may provide a list of types of expandable shelters and types of cassettes in a warehouse, a depot, a loading dock, already in use, in transit, etc. that a known or registered user already owns.

The inventory pull down menu may provide a description, a quantity, and/or a location of each the qualified expandable shelters and/or cassettes already owned by the registered user. For example, the expandable shelters and/or cassettes may include an identification and tracking tag for managing inventory of the expandable shelters and/or cassettes. The tracking tag may include a global positioning system tracking unit, a radio-frequency identification (RFID) unit, a bar code, or a quick response (QR) code for tracking quantities and locations of expandable shelters and/or cassettes managed by a registered or known user.

The user interface 502 may provide expandable shelters and/or cassettes based on standards (e.g., military standards) and/or requirements associated with a selected type of user (e.g., selected Air Force type user 414) in the drop down menu 404, to determine qualified shell components needed to build the camp. For example, the user interface 502 may provide expandable shelters and/or cassettes based on Basic Expeditionary Airfield Resources (BEAR) standards and/or requirements for the selected Air Force type user. As another example the user interface 502 may provide expandable shelters and/or cassettes based on Force Provider standards and/or requirements for a selected Army type user.

The user interface 502 may include a drop down menu 506 listing qualified expandable shelters 508(1) and 508(2). The drop down menu 506 may provide a description of the qualified expandable shelters 508(1) and 508(2). For example, the drop down menu 506 may describe a qualified expandable shelter as a 3-in-1 expandable shelter, a 5-in-1 TRICON, 5-in-1 BICON, 5-in-1 QUADCON, etc. A quantity 510 associated with each of the qualified expandable shelters 508(1) and 508(2) may be displayed in the drop down menu 506. The quantity 510 associated with each of the qualified expandable shelters 508(1) and 508(2) may be determined based at least in part on the received information via the drop down menus 404, 424, 428, and/or the standards and/or requirements associated with the selected type of user. While FIG. 5 illustrates two different types of qualified shelters 508(1) and 508(2) (e.g., 3 of the 3-in-1 type shelters, and 3 of the 5-in-1 TRICON type shelters) being listed in the drop down menu 506, any number of qualified shelters may be listed. For example, based at least in part on the received information via the drop down menus 404, 424, 428, and/or the standards and/or requirements associated with the selected type of user, the drop down menu 506 may list four qualified expandable shelters (e.g., a 3-in-1 expandable shelter, a 5-in-1 TRICON, 5-in-1 BICON, 5-in-1 QUADCON, etc.) in the drop down menu 506.

The user interface 502 may provide a drop down menu 512 listing qualified cassettes 514(1), 514(2), 514(3), 514(4) 514(5), 514(6), and 514(7). A quantity 516 associated with each of the qualified cassettes 514(1) through 514(7) may be displayed in the drop down menu 512. The quantity 516 associated with each of the qualified expandable cassettes 514(1) through 514(7) may be determined based at least in part on the received information via the drop down menus 404, 424, 428, the standards, and/or requirements associated with the selected type of user. While FIG. 5 illustrates seven qualified cassettes 514(1) through 514(7) being displayed, any number of qualified cassettes may be displayed.

The user interface 502 may provide a window 518 for an interactive geographic mapping system 520. For example the interactive geographic mapping system 520 may present or display the selected geographic location (e.g., Afghanistan 418) in a map made via the drop down menu 416 or the mapping service in the user interface 402. Further, the interactive geographic mapping system 520 may present the selected geographic location as a political map, topographic map, a geographic map, or the like. Further, the interactive geographic mapping system 520 may present the selected geographic location in a two-dimensional format or a three-dimensional format.

The user interface 502 may receive a selection of the qualified cassettes 514(1)-514(7) and/or the qualified shelters 508(1) and 508(2), and present visual representations of the selected qualified cassettes and/or the qualified shelters in the display 518. For example the user interface 502 may receive a user selection 522 of the 5-in-1 TRICON qualified shelter 508(2), provided in the drop down menu 506, and present a graphical representation (e.g., visual representation) of the selected 5-in-1 TRICON qualified shelter 508(2) in the display 518. Further, the user interface 502 may present the graphical representation of the selected 5-in-1 TRICON qualified shelter 508(2) at a user specified location 524.

The user interface 502 may receive a user selection 526 of the power cassette 514(1), provided in the drop down menu 512, and present a graphical representation of the selected power cassette 514(1) in the display 518. Further, the user interface 502 may present the graphical representation of the selected qualified cassettes and/or the qualified shelters in a manner indicating (e.g., demarcating) 528 expanded interior portions (e.g., expanded interior portions 130(C) and 130(D)) configured to house the selected power cassette 514(2). In addition or alternatively, the user interface 502 may present demarcations 528 indicating expanded interior portions configured to house the qualified cassettes 514(1) through 514(7) listed in the drop down menu 512. Subsequent to presenting demarcations 528 of the expanded interior portions of the qualified expandable shelters 508(1) and 508(2), the user interface 502 may receive a selection 530 of a demarcated expanded interior portion 528, and display the selected power cassette 514(1) in the selected expanded interior portion 530 configured to house the selected power cassette 514(1).

The user interface 502 may receive a user selection to interconnect one of the qualified expandable shelters presented in the display 518 to another qualified expandable shelter presented in the display 518. The user selection to interconnect qualified expandable shelters may include a selection to interconnect a front or a back of one qualified expandable shelter to a front or back of another qualified expandable shelter. For example, the user interface may receive a user selection 532(A) of a front 534 of the qualified expandable shelter 508(1) along with a user selection 532(B) of a back 536 of the qualified shelter 508(2) to interconnect the front 534 of the qualified expandable shelter 508(1) with the back 536 of the qualified shelter 508(2). Further, the user interface 502 may receive a user selection to orientate the expandable shelters relative to one another, and/or relative to the geographic features in the display. For example, the user interface 502 may receive a user selection to orientate individual expandable shelters or interconnected expandable shelters relative to cardinal points 538 (i.e., north, east, south, and west directions).

The user interface 502 may provide intelligent camp building features. For example the user interface may provide intelligent camp building features that include not allowing a user to locate a selected qualified cassette in an expanded interior portion of a selected expandable shelter not configure to house the selected qualified cassette. The intelligent camp building features of the user interface may include not allowing a user to interconnect selected qualified expandable shelters not configured to interconnect with each other. Further, the intelligent camp building features of the user interface may include not allowing a user to specifically locate qualified expandable shelters in geographic locations not suitable for the qualified expandable shelters. For example the intelligent camp building features of the user interface may not allow a user to locate qualified expandable shelters in bodies of water (e.g., a lake, a river, a creek, a stream, a wetland, a marsh, an ocean), on steep pitches (e.g., a hill side, a ditch, a crevasse), on obstructions (e.g., existing buildings, group of trees, boulders), etc.

While FIGS. 4 and 5 describe user interfaces 402 and 502 receiving user selections, the user interfaces 402 and 502 may receive drag-and-drop actions, mouse gestures, point-and-click actions, snap actions, or the like to provide information and build a desired camp. Further, while FIGS. 4 and 5 describe pull down menus, other user interface control graphical user interface (GUI) elements may be used.

### Example Processes

FIG. 6 and FIG. 7 illustrate processes 600 and 700 respectively, related to building a desired camp. The processes 600 and 700 are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

FIG. 6 is a flow diagram of a process 600 for a user to provide information about a desired camp. At 602, the process 600 includes receiving information identifying a type of user of expandable shelters. The different types of potential users of expandable shelters may include an Army type user, a Marine Corps type user, a Navy type user, an Air Force type user, a Coast Guard type user, a defense contractor type user, a disaster relief type user, a construction contractor type user, etc. Each of the different types of potential users may be associated with standards (e.g., military standards) and/or requirements. For example, an Air Force type user may be associated with Basic Expeditionary Airfield Resources (BEAR) standards and/or requirements, or an Army type user may be associated with Force Provider standards and/or requirements. As discussed above with regard to FIGS. 4 and 5, the standards and/or requirements may be used to determine qualified expandable shelters and/or cassettes.

At 604, the process 600 includes receiving information identifying a geographic location where the expandable shelters are to be located. The information identifying a geographic location may include a country or state, a province, a city, a town, a latitude and a longitude coordinate and so on. The geographic locations may be associated with a frigid climate, temperate climate, or a torrid climate of the Earth. The expandable shelters and/or cassettes may be configured for the climates associated with the geographic locations the shelters and/or cassettes may be deployed to. At 606, the process 600 includes receiving information identifying a season as to what time of the year the expandable shelters are to be deployed to the geographic location. For example, the expandable shelters may be deployed to a geographic location during the summer months, autumn months, winter months, spring months, all season, or a combination of seasons associated with a geographic location. The expandable shelters and/or cassettes may be configured based on the season of which the geographic location the expandable shelters are to be deployed.

At 608, process 600 includes receiving information identifying a number of people to occupy the expandable shelters. In some instances, the number of people occupying the expandable shelters may be at least about 25 people and up to at most about 600 people.

At 610, process 600 includes receiving information identifying a gender of the users (e.g., group of people) to occupy the expandable shelters. For example a group of people consisting of all male individuals, a group of people consisting of both male and female individuals, or a group of people consisting of all female individuals may occupy the expandable shelters. The standards and/or requirements associated with the different types of potential users may specify a minimum and/or a maximum quantity and type of expandable shelters and/or cassettes based on the number of people and/or the gender of the people to occupy the expandable shelters. For example, the standards and/or requirements associated with the Army (e.g., Force Provider standards and/or requirements) may specify a larger number of expandable shelters and/or cassettes for a group of people consisting of both male and female individuals than for a group of people consisting of all male or all female individuals.

At 612, process 600 includes determining a type of the expandable shelters and/or a type of the cassettes to be housed in the expandable shelters based on the received information. For example, types of expandable shelters and/or cassettes may be determined based on the standards and/or requirements (e.g., BARE standards and/or Force Provider standards) associated with the type of user (e.g., Air Force type user, and/or Army type user).

At 614, process 600 includes providing information to a user identifying the type of expandable shelters and/or cassettes based on the received information. The types of expandable shelters and/or cassettes may be provided as a list (e.g., drop down menu 504 of FIG. 5) and/or as graphical representations presented in an interactive geographical display (e.g., interactive geographic mapping system 520 of FIG. 5).

At 616, process 600 includes determining a number of the expandable shelters and identifying the number of the expandable shelters to a user. The number of qualified expandable shelters may be based on the type of user, the standards and/or requirements associated with the type of user, the gender of the group of people to occupy the expandable shelters, and/or the number of people to occupy the expandable shelters.

At 618, process includes determining a number of the cassettes and identifying the number of the cassettes to a user. The qualified cassettes may be based on the number and type of qualified expandable shelters. Further, the quantity of qualified cassettes may be based on the type of user, the standards and/or requirements associated with the type of user, the gender of the group of people to occupy the expandable shelters, and/or the number of people to occupy the expandable shelters.

FIG. 7 is a flow diagram of a process 700 for a user to build a desired camp. At 702, the process 700 includes displaying qualified expandable shelters and/or cassettes. The qualified expandable shelters and/or cassettes may be displayed in a list (e.g., drop down menu 504) and/or as graphical (e.g., visual) representations presented in an interactive geographical display (e.g., interactive geographic mapping system 520 of FIG. 5). As discussed above, the type of expandable shelters and/or cassettes may be determined based on the received information.

At 704, the process 700 includes displaying the visual representation of the expandable shelters in a manner indicating (e.g., demarcating) where the visual representations of a cassette may be positioned. The demarcations may indicate expanded interior portions configured to house selected cassettes and/or indicating expanded interior portions configured to house qualified cassettes. For example, a demarcation may indicate an expanded interior portion configured to house a particular type of cassette selected by a user, or a demarcation may indicate an expanded interior portion configured to house cassettes in general.

At 706, the process 700 includes receiving a selection of a qualified cassette. For example, a user may select a power cassette (e.g., power cassette 514(2)) provided in a drop down menu (e.g., drop down menu 512). At 708, the process 700 includes displaying the selected cassette in the indicated position of the displayed visual representation of the expandable shelter. For example, the selected cassette may be displayed in a user selected demarcated expanded interior portion configured to house qualified cassettes.

At 710, the process 700 includes receiving an indication to interconnect one visual representation of an expandable shelter with another visual representation of an expandable shelter. For example, a user may select a front or a back of one visual representation of an expandable shelter to a front or a back of another visual representation of an expandable shelter.

### CONCLUSION

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. For example, in various embodiments, any of the structural features and/or methodological acts described herein may be rearranged, modified, or omitted entirely. For example, the shape, size, and configuration of the expandable shelter and/or the cassettes may be varied.

What is claimed is:

1. A computer-implemented method comprising:
under control of one or more computing systems configured with specific executable instructions,
receiving information identifying:
a user of one or more expandable shelters;
a geographic location where the one or more expandable shelters are to be located;
a number of users to utilize the one or more expandable shelters;
based at least in part on the received information, determining a type of the one or more expandable shelters and a type of one or more cassettes to be housed in the one or more expandable shelters; and
providing information to a user identifying the type of the one or more expandable shelters and the type of the one or more cassettes.

2. The computer-implemented method of claim 1, further comprising:
based at least in part on the received information, determining a number of the one or more expandable shelters,
wherein the information provided to the user identifies the number of the one or more expandable shelters.

3. The computer-implemented method of claim 1, further comprising:
based at least in part on the received information, determining a number of the one or more cassettes,
wherein the information provided to the user identifies the number of the one or more cassettes.

4. The computer-implemented method of claim 1, wherein the received information further identifies a gender of the users to utilize the one or more expandable shelters.

5. The computer-implemented method of claim 1, wherein at least one of the one or more expandable shelters comprises an enclosure defining an interior and including a top, bottom, front, back, and two sides, at least one side being displaceable to deploy from a stowed position adjacent to the enclosure to a use position out and away from the enclosure, wherein when the displaceable side is in the use position, the displaceable side defines an expanded interior portion interconnected to the interior of the enclosure, and
each of the one or more cassettes are configured to be displaceably housed in the enclosure of the at least one of the one or more expandable shelters to deploy from a stowed position in the interior of the enclosure to a use position removeably coupled in the expanded interior portion of the displaceable side, wherein each of the one or more cassettes provide an allocated resource when in the use position.

6. The computer-implemented method of claim 1, further comprising:
upon providing the information to the user, displaying a map of the identified geographic location;
receiving user input for a visual representation corresponding to an expandable shelter of the one or more expandable shelters, the user input positioning the visual representation of the expandable shelter at a specific position on the map; and
displaying the at least one visual representation of the expandable shelter at the specific position on the map.

7. The computer-implemented method of claim 6, further comprising:
upon displaying the at least one visual representation of the expandable shelter at the specific location on the map, receiving a selection of a visual representation corresponding to at least one of the one or more cassettes; and
upon receiving the selection of the visual representation of the cassette, displaying the visual representation of the expandable shelter in a manner indicating where the visual representation of the cassette may be positioned.

8. The computer-implemented method of claim 7, further comprising:
upon displaying the visual representation of the expandable shelter in the manner indicating where the visual representation of the cassette may be positioned, receiving a selection of the indication where the visual representation of the cassette may be positioned; and
upon receiving the selection of the indication where the visual representation of the cassette may be positioned, displaying the visual representation of the cassette in the selected position in the visual representation of the expandable shelter.

9. The computer-implemented method of claim 1, wherein the information identifying the user of expandable shelters comprises a military branch, a defense contractor, a disaster group, a construction contractor, or an expedition group.

10. The computer-implemented method of claim 1, wherein the received information further identifies a climate the one or more expandable shelters are to be used in.

11. A computer-implemented method comprising:
under control of one or more computing systems configured with specific executable instructions,
receiving information identifying:
a user of one or more expandable shelters;
a geographic location where the one or more expandable shelters are to be located;
a number of users to utilize the one or more expandable shelters;
based at least in part on the received information, determining a type of the one or more expandable shelters and a type of one or more cassettes to be housed in the one or more expandable shelters; and
displaying, in a map of the geographic location, at least one visual representation corresponding to the determined type of expandable shelters, and at least one visual representation corresponding to the determined type of cassettes.

12. The computer-implemented method of claim 11, further comprising:
displaying the visual representation of the expandable shelter in a manner indicating where the visual representation of the cassette may be positioned.

13. The computer-implemented method of claim 11, further comprising:
displaying, in the map of the geographic location, at least one other visual representation corresponding to the determined type of expandable shelters, and
receiving an indication from the user to interconnect the at least one visual representation of the expandable shelter to the at least one other visual representation of the expandable shelter.

14. One or more non-transitory computer-readable storage media storing computer-readable instructions that, when executed, instruct a processor to perform operations comprising:
receiving information identifying:
a user of one or more expandable shelters;
a geographic location where the one or more expandable shelters are to be located;
a number of users to utilize the one or more expandable shelters;
based at least in part on the received information, determining a type of the one or more expandable shelters and a type of one or more cassettes to be housed in the one or more expandable shelters; and
providing information to a user identifying the type of the one or more expandable shelters and the type of the one or more cassettes.

15. The one or more computer-readable storage media of claim 14, further comprising:
based at least in part on the received information, determining a number of the one or more expandable shelters,
wherein the information provided to the user identifies the number of the one or more expandable shelters.

16. The one or more computer-readable storage media of claim 14, further comprising:
based at least in part on the received information, determining a number of the one or more cassettes,
wherein the information provided to the user identifies the number of the one or more cassettes.

17. The one or more computer-readable storage media of claim 14, wherein the received information further identifies a gender of the users to utilize the one or more expandable shelters.

18. The one or more computer-readable storage media of claim 14, wherein at least one of the one or more expandable shelters comprises an enclosure defining an interior and including a top, bottom, front, back, and two sides, at least one side being displaceable to deploy from a stowed position adjacent to the enclosure to a use position out and away from the enclosure, wherein when the displaceable side is in the use position, the displaceable side defines an expanded interior portion interconnected to the interior of the enclosure, and
each of the one or more cassettes are configured to be displaceably housed in the enclosure of the at least one of the one or more expandable shelters to deploy from a stowed position in the interior of the enclosure to a use position removeably coupled in the expanded interior portion of the displaceable side, wherein each of the one or more cassettes provide an allocated resource when in the use position.

19. The one or more computer-readable storage media of claim 14, further comprising:
upon providing the information to the user, displaying a map of the identified geographic location;
receiving user input for a visual representation corresponding to an expandable shelter of the one or more expandable shelters, the user input positioning the visual representation of the expandable shelter at a specific position on the map; and
displaying the at least one visual representation of the expandable shelter at the specific position on the map.

20. The one or more computer-readable storage media of claim 19, further comprising:
upon displaying the at least one visual representation of the expandable shelter at the specific location on the map, receiving a selection of a visual representation corresponding to at least one of the one or more cassettes; and
upon receiving the selection of the visual representation of the cassette, displaying the visual representation of the expandable shelter in a manner indicating where the visual representation of the cassette may be positioned.

21. The one or more computer-readable storage media of claim 14, wherein the information identifying the user of expandable shelters comprises a military branch, a defense contractor, a disaster group, a construction contractor, or an expedition group.

22. The one or more computer-readable storage media of claim 14, wherein the received information further identifies a climate the one or more expandable shelters are to be used in.

23. One or more non-transitory computer-readable storage media storing computer-readable instructions that, when executed, instruct a processor to perform operations comprising:
receiving information identifying:
a user of one or more expandable shelters;
a geographic location where the one or more expandable shelters are to be located;
a number of users to utilize the one or more expandable shelters;
based at least in part on the received information, determining a type of the one or more expandable shelters and a type of one or more cassettes to be housed in the one or more expandable shelters; and
displaying, in a map of the geographic location, at least one visual representation corresponding to the determined type of expandable shelters, and at least one visual representation corresponding to the determined type of cassettes.

24. The one or more computer-readable storage media of claim 23, further comprising:
displaying the visual representation of the expandable shelter in a manner indicating where the visual representation of the cassette may be positioned.

25. The one or more computer-readable storage media of claim 23, further comprising:
displaying, in the map of the geographic location, at least one other visual representation corresponding to the determined type of expandable shelters, and
receiving an indication from the user to interconnect the at least one visual representation of the expandable shelter to the at least one other visual representation of the expandable shelter.
